(19) United States
(12) Patent Application Publication
(10) Pub. No.: US 2016/0267572 A1
(43) Pub. Date: Sep. 15, 2016

(54) SYSTEM AND METHOD FOR GENERATION OF A REAL-TIME PERSONALIZED PRICE ADJUSTMENT

(71) Applicant: Personali Inc., Waltham, MA (US)

(72) Inventors: Keren ZIMMERMAN, Tel Aviv (IL); Noam JAVITS, Tel Aviv (IL)

(73) Assignee: Personali Inc., Waltham, MA (US)

(21) Appl. No.: 15/164,247

(22) Filed: May 25, 2016

Related U.S. Application Data
(63) Continuation of application No. PCT/US2014/069305, filed on Dec. 9, 2014.
(60) Provisional application No. 61/914,419, filed on Dec. 11, 2013.

(51) Int. Cl. G06Q 30/06; G06Q 30/02

(52) U.S. Cl. CPC G06Q 30/0633; G06Q 30/0283

(57) ABSTRACT

A method and system for generating a real-time personalized price adjustment are provided. The method includes receiving by an e-commerce server a message that at least one product is added to an electronic shopping cart of an electronic-commerce website (e-commerce) displayed on a consumer device; collecting by the e-commerce server at least one user-activity parameter related to a user of the consumer device; collecting at least one product-related parameter to the at least one product; generating in real-time a price adjustment for purchasing the at least one product, wherein the price adjustment is generated based on the at least one user-activity parameter and the at least one product-related parameter; and displaying of the price adjustment in the electronic shopping cart in association with the at least product type.

### CROSS-REFERENCE TO RELATED APPLICATIONS

This application is a continuation of International Application No. PCT/US2014/069305 filed on Dec. 9, 2014 which claims the benefit of U.S. Provisional Application No. 61/914,419 filed Dec. 11, 2013, the contents of which are hereby incorporated by reference.

### TECHNICAL FIELD

The disclosure generally relates to a computerized negotiation platform for electronic commerce (e-commerce) websites, and more specifically to a system and method for generating real-time personalized price adjustments for shoppers of e-commerce websites.

### BACKGROUND

The way people shop has significantly progressed since the development of the worldwide web (WWW). Consumers can now shop from the convenience of their home, office, or while on the road using portable devices. Popular e-commerce, websites such as Amazon.com® and Shopping.com®, though different by nature, allow consumers to purchase goods and services directly through the website, sometimes at a much lower price than the price suggested by local merchants. From a merchant's point of view, the worldwide web allows access to a worldwide market of consumers.

The services provided by e-commerce websites such as Shopping.com® belong to a category of websites that provide comparison shopping engines (CSE) that assist consumers by presenting prices and information about a product the consumer may be interested in purchasing. In response to a consumer's query, the consumer is provided with a list of possibilities based on characteristics such as price and popularity. The CSE is generally considered to be an effective tool for consumers.

As another example, Priceline.com® allows a consumer to make a bid for a traveling service, such as a hotel room reservation. In response, the service provider (e.g., either Priceline.com® or the hotel), can either accept or reject that bid. In response, the consumer can either search for another alternative or raise the bid until it is accepted by the service provider. The disadvantage of such an approach is that the consumer does not know the particulars of the vendor or service provider. For example, the consumer selects the area and rating of a hotel he or she desires to stay at, but the consumer cannot bid on a specific hotel. Further, all bids placed by the consumer are binding and no true negotiation take place.

Other disadvantages typically associated with e-commerce websites relate to the lack of personal interaction between the consumer and the merchant. At best, the personal interaction is limited to a chat with a sale representative who can provide more information about the goods/services that can be purchased through the e-commerce website. Another way to motivate consumers to purchase through e-commerce websites is to offer generic discounts to all the consumers visiting the website. Therefore, consumers are less inclined to follow through on an online purchase and abandon their electronic shopping carts.

It would therefore be advantageous to overcome the limitations of the prior art e-commerce solutions by providing an effective and personalized solution to motivate consumers to purchase online.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all embodiments. Its sole purpose is to present some concepts of one or more embodiments in a simplified form as a prelude to the more detailed description that is presented later. For convenience, the term some embodiments may be used herein to refer to a single aspect or multiple embodiments of the disclosure.

The disclosure relates in various embodiments a method for generating a real-time personalized price adjustment. The method comprises receiving by an e-commerce server a message that at least one product is added to an electronic shopping cart of an electronic-commerce website (e-commerce) displayed on a consumer device; collecting by the e-commerce server at least one user-activity parameter related to a user of the consumer device; collecting at least one product-related parameter to the at least one product; generating in real-time a price adjustment for purchasing the at least one product, wherein the price adjustment is generated based on the at least one user-activity parameter and the at least one product-related parameter; and displaying of the price adjustment in the electronic shopping cart in association with the at least product type.

The disclosure further relates in various embodiments a system for generation of real-time personalized price adjustment. The system comprises a processor; and, a memory coupled to the processor, the memory containing instructions that, when executed by the processor, configure the system to: receive by an e-commerce server a message that at least one product is added to an electronic shopping cart of an electronic-commerce website (e-commerce) displayed on a consumer device; collect by the e-commerce server at least one user-activity parameter related to a user of the consumer device; collect at least one product-related parameter to the at least one product; generate in real-time a price adjustment for purchasing the at least one product, wherein the price adjustment is generated based on the at least one user-activity parameter and the at least one product-related parameter; and display of the price adjustment in the electronic shopping cart in association with the at least product type.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a network system utilized to disclose the various embodiments.

FIG. 2 is a flowchart describing a method for modifying an online shopping chart in accordance with an embodiment.

FIG. 3 is a flowchart describing the generation of price adjustments in accordance with an embodiment.

### DETAILED DESCRIPTION

The embodiments disclosed herein are only examples of the many possible advantageous uses and implementations of the innovative teachings presented herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

As an example of the above, some exemplary embodiments disclosed herein configure a system to generate price adjustments to products added to an on-line shopping cart. Without limiting the scope of the disclosed embodiments, a product or products disclosed herein include goods and/or services. The price adjustment is performed during a browsing session of an e-commerce website, which thereby may trigger to a user (e.g., a consumer) to complete the purchase transaction. In an embodiment, a price adjustment of a product is performed based on a number of characteristics related to the user, the product and/or information received from a merchant. The disclosed embodiments further configured a system to modify the contents of the user shopping cart based in part on the adjusted price.

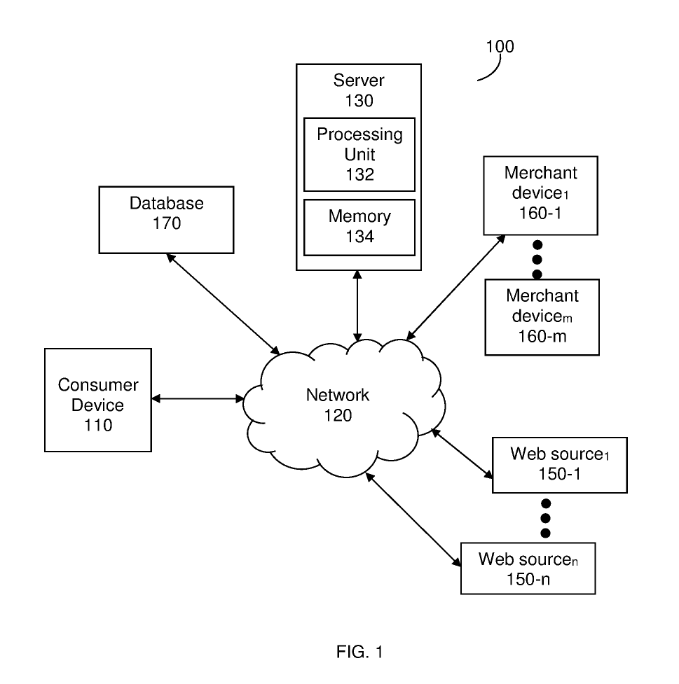

FIG. 1 depicts an exemplary and non-limiting schematic diagram of a network system 100 utilized to describe the various disclosed embodiments. A user, by means of a consumer device 110, is connected to a network 120. The device 110 may be, but is not limited to, a personal computer (PC), a laptop computer, a smart phone, a tablet computer, a wearable computing device, and the like. The consumer device 110 is configured to allow access to one or more web sources 150-1 through 150-n (collectively referred hereinafter as web sources 150 or individually as a web source 150, merely for simplicity purposes) for at least the purpose of performing e-commerce transactions. As an example, a web source 150 may be a website or a datacenter that hosts an e-commerce website. It should be noted that e-commerce website may be, but is not limited to, online websites, travel websites, services websites, and any other web source through which the user is able to purchase goods or services. It should be further noted that-commerce website may be accessed through a web browser or an application installed on the consumer device 110.

The network 120 can be wired or wireless, a local area network (LAN), a wide area network (WAN), a metro area network (MAN), the Internet, the worldwide web (WWW), the likes, and any combinations thereof.

An e-commerce server 130 is also connected to the network 120. The e-commerce server 130 typically comprises a processing system 132 coupled to a memory 134. In one implementation, the memory 134 contains instructions that when executed by the processing system 132 results in the performance of the methods discussed herein below. Specifically, the memory processing system 132 may include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system 132 to perform the various functions described herein. In an embodiment, the processing system 132 may include one or more processors. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The consumer device 110 can communicate with the web sources 150 over the network 120. The web sources 150 are operative by merchant devices 160-1 through 160-m (collectively referred hereinafter as merchant devices 160 or individually as a merchant device 160, merely for simplicity purposes) respectively. One merchant device 160, for example merchant device 160-1, may operate one or more web sources 150 such as, for example, web sources 150-1 and 150-2. A single web source 150 such as, for example, web source 150-1, may be operated by a plurality of merchant devices 160, for example merchant device 160-1 and 160-2.

According to various disclosed embodiments, the e-commerce system 130 is configured to track the activity of a user of the consumer device 110. This can be performed using a script or other code executed over the device 110 and programmed to collect data with respect to the user shopping activity, e-commerce websites the user visits, and products placed in shopping carts. In an embodiment, the e-commerce server 130 is configured to receive a message that a product was placed in a shopping cart of an e-commerce website. Such a message is sent for example, from the device 110, as the product is placed in the shopping cart. The identification that a product is placed in the shopping cart may be derived by a script or a cookie (or similar data structures) saved locally in the consumer device 110.

In an alternative embodiment, the message that the user added a product to shopping cart may be provided by the web source 150 hosting the respective e-commerce website. Such a message may also include an identifier of the user and/or consumer device 110. Upon identification, the e-commerce server 130 is configured to collect one or more parameters related to the activity of the user of the consumer device 110. The received message may include, for example, a full list of products or a partial list of products (each product identified by its name or any other unique identifier) in the shopping cart. The message may also include a current price of each such product, a time that the product was added to the cart, and/or the quantity of each product.

The collection of user activity parameters may be achieved by crawling through the web sources 150 and identifying the user activities therein. In another embodiment, the parameters may be collected by a script executed over the consumer device 110. The user activity parameters may include, for example, behavioral information, shopping history, such pervious purchases, pervious e-commerce websites and/or products the user browsed, demographic information, the landing pages, and so on. Behavioral information may include, for example, the amount of time the user spent searching for a certain good or service, one or more gestures received from the user of the consumer device 110, queries, portions thereof, and so on.

The e-commerce server 130 is configured to identify parameters related to each product placed in the shopping cart. The product-related parameters include, for example, a product name, the type of product, its current price, shipping information, inventory information, similar available product, special offers, and more. The product-related parameters may be received from any one of the merchant devices 160.

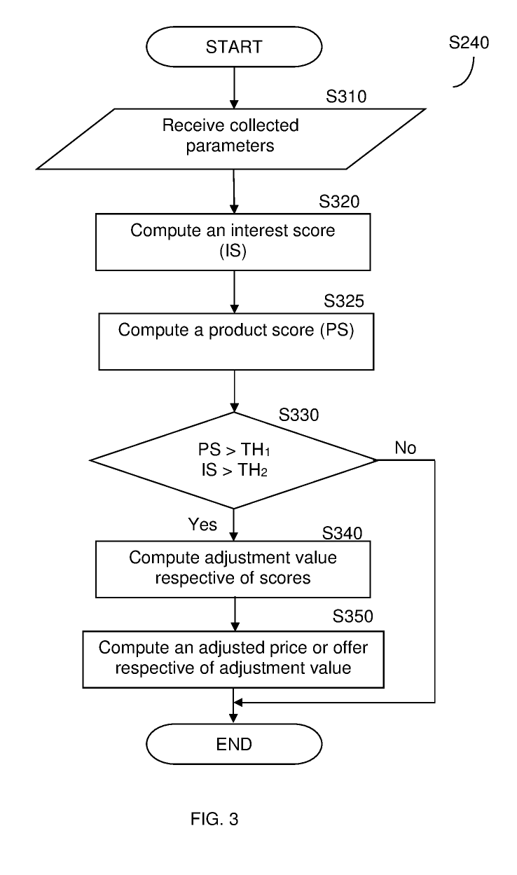

Based on the collected user-activity and/or product related parameters, the e-commerce server 130 is configured to offer a price adjustment to each, some, one, or all products placed in the shopping cart. In an exemplary embodiment, the price adjustment may be in a form of a discounted price, a price increase, a shipping cost discount/increase, a different shopping method, add-on product, a combination thereof, and so on. The computation of the price adjustments is based on predetermined criteria established by the merchant, such as desired sales totals, desired profit margins, desired inventory levels, and the like, and/or based on the user interest in the specific product. The range of available price adjustments may be established by the merchant, determined according to a process described herein below with respect to FIG. 3.

The price adjustment is sent, by the e-commerce server 130, for display in the electronic shopping cart in association with the product. The adjusted price may replace the original price or be displayed with the original price. According to another embodiment, the adjusted price is displayed by the e-commerce server 130 on a display of the consumer device 110 and displayed in the electronic shopping cart upon a predefined trigger. Such a trigger may result, for example, when a predefined time elapsed since the product was initially placed in the cart, once the user browsers to a different website, changing the quantity of the product in the chart, an approval received from the consumer device 110, and so on.

Further connected to the network is a database 170 for storing at least the user-activity parameters related to the users. These stored parameters may be accessed from the database 170 when collecting parameters related to user who previously accessed the same webpage. It should be noted that while the system 100 is described in a manner where the e-commerce server 130 is a separate device from the web source 150 it should not be viewed as a limitation of the disclosed embodiments. In certain exemplary embodiments, the e-commerce server 130 and the web source 150 may be implemented on the same physical device.

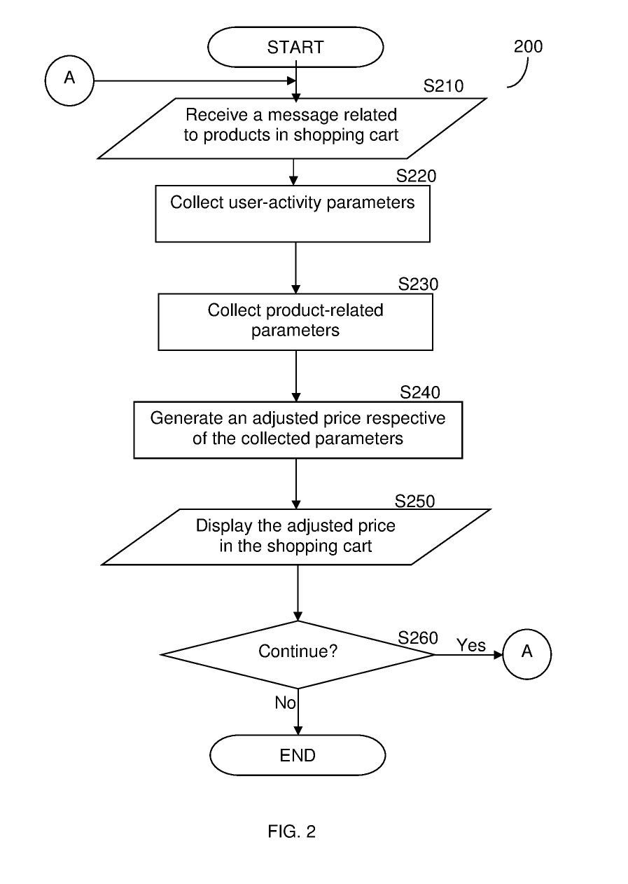

FIG. 2 depicts an exemplary and non-limiting flowchart 200 describing the operation of a method for generating real-time personalized price adjustments of products stored in an electronic shopping cart in accordance with embodiments. The method may be performed by the e-commerce server 130.

In S210, a message that a product added to an electronic shopping cart from, for example consumer device 110, is received. Such a message may be received from a consumer device (e.g., device 110) or an e-commerce website (e.g., one of sources 150). As noted above, the received message may include, for example, a full list of products or a partial list of products (each product identified by its name or any other unique identifier) in the shopping cart. The message may also include a current price of each such product, a time that the product was added to the cart, and/or the quantity of each product.

In S220, user-activity parameters are collected. In S230, parameters related to the product are received from a merchant device. The various non-limiting examples for the user-activity and product-related parameters, and the various non-limiting examples for collecting such parameters are provided above.

In S240, an adjusted price is computed based on the user-activity parameters and/or product-related parameters. The price adjustment may be computed for each product, one product, some products, or all products designated in the received message. As an example, if the user of the consumer device 110 is identified as located in Washington D.C., and the product added to the electronic shopping cart is available in Washington D.C., the shipment costs may be adjusted accordingly.

In another embodiment, a price adjustment may be generated on a related product, or a price adjustment on the added product with the purchase of a related product. As an example, if the user had visited multiple webpages selling scarves before adding a winter coat to the electronic shopping cart, and the price margin on scarves is above a certain threshold, the price of the scarf may be adjusted or the price of the coat may be adjusted upon adding a scarf to the cart. Products may be considered related based on merchant selection, user behavior information, or other applicable means. A non-limiting process for computing a price adjustment is provided in FIG. 2.

In S250, the adjusted price is displayed in the electronic shopping cart. In another embodiment, an offer is displayed to receive the adjust price with the purchase of a related product, or an adjusted price of a related product is displayed. In an embodiment, the adjusted price is displayed on the consumer device 110 upon a predefined trigger. Such a trigger may result, for example, when a predefined time elapsed since the product was initially placed in the cart, once the user browses to a different website, changing the quantity of the product in the chart, an approval received from the consumer device, and so on.

In S260, it is checked whether to continue with the operation (e.g., based on an updated contents of a shopping cart). If so, execution continues with S210; otherwise, execution terminates. According to one embodiment, the collected user-activity parameters are stored in a database, for example the database 170, for further use.

As a non-limiting example, a message that a polo shirt has been added to an electronic shopping cart in an e-commerce website is received. In this example, the collected user-activity parameters indicate that the user tends to drop transactions upon display of the shipment costs. The user-activity parameters further indicate that the consumer device 110 is located in the California. The product-related parameters, according to this example, indicate that same type of polo shirt is available for purchase in the New York.

Respective thereto, the e-commerce server 130 determines the maximum discount rate available for the shipment costs. Such a discounted rate may motivate the user to complete the purchase transaction due to the fact the product is shipped from New York. The discounted shipment price is then added to the original price displayed in the shopping cart in association with the polo shirt. The e-commerce server 130 may further generate a notification specifying the discount rate and display the notification in the shopping cart.

Following the above example, collected user-activity parameters may further indicate that the user tends to complete more transactions upon display of sales on khaki pants. The user has not yet added khaki pants to the electronic shopping cart. Parameters related to the polo shirt and the khaki pants may be also received or collected from the respective merchant. The product-related parameters may indicate that the khaki pants are available for sale with a price margin that is above a predefined threshold.

In this example, the price adjustment may be in form of an add-on product, in which the maximum discount rate available for the khaki pants is determined. The discounted price of the khaki pants is then displayed next to the original price of the polo shirt displayed in the shopping cart. The e-commerce server 130 may further generate a notification specifying the discount rate and display the notification in the shopping cart.

FIG. 3 depicts an exemplary and non-limiting flowchart S240 for computing price adjustments according to an embodiment. In S310, the method processes user-activity and product-related activity (products) collected in S220, S230 (FIG. 2).

In S320, an interest score is computed based on the collected user-activity parameters. The interest score indicates the degree of interest of the user in a product placed in the shopping chart. In a non-limiting configuration, a high score means high interest, while a low score means low interest. If multiple products are in the electronic shopping cart, the interest scores associated with the user for each item are averaged into a total interest score.

In S325, a product score is computed respective of the collected product-related parameters. The product score represents the probability that the product's price would be adjusted. In a non-limiting configuration, a high score and low score respectively means a high or low probability that, for example, the merchant will accept any price adjustment. For example, if the current price and inventory of the product are both high, the product score is high. S325 may be performed concurrently with S320.

In an exemplary embodiment, each score is computed by assigning a numerical value to each parameter and aggregating or averaging the assigned numerical values. The aggregation or average may be based on different weights assigned to each parameter. In a non-limiting example, if a user parameter is a landing page directed to Amazon.com®, on a scale of 1 to 10, 1 being low interest and 10 being high interest, Google.com® may have a value of 10 and Craigslist.com® may have a value of 2. The product score of the product(s) may be computed in a similar manner.

In S330, each of the interest score (of the user) and the product score is compared to an adaptive threshold which is predefined differently for each score. A crossing of both thresholds by both product scores indicates that adjusting the price may facilitate a completion of a purchase transaction.

In S340, an adjustment value is computed as a function of the interest and the product scores. As an example, if a product can be discounted from 5% to 25% while still maintaining profitability, a computed high interest score and a low product score would result in a 5% price adjustment. On the other hand, a low interest score and a high product score would result in a 25% price adjustment.

In S350, an adjusted price or offer is generated respective of the adjustment value. For example, the computed discount is applied on the product price. The generated price adjustment is output. It should be noted that the generated price adjustment is personalized to the user as the interest score is generated based on the parameters related to the user shopping on-line.

The various embodiments of the disclosed embodiments are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for generating a real-time personalized price adjustment, comprising:
receiving by an e-commerce server a message that at least one product is added to an electronic shopping cart of an electronic-commerce website (e-commerce) displayed on a consumer device;
collecting by the e-commerce server at least one user-activity parameter related to a user of the consumer device;
collecting at least one product-related parameter to the at least one product;
generating in real-time a price adjustment for purchasing the at least one product, wherein the price adjustment is generated based on the at least one user-activity parameter and the at least one product-related parameter; and
displaying of the price adjustment in the electronic shopping cart in association with the at least product type.

2. The method of claim 1, further comprising:
storing the user-activity parameters in a database.

3. The method of claim 1, wherein the message is received from any one of: the consumer device, a web source hosting the e-commerce website.

4. The method of claim 1, wherein the at least one user-activity parameter includes at least one of: behavioral information, shopping history information, and demographic information.

5. The method of claim 1, wherein the at least one product-related parameter includes at least one of: a type of product, a product price, shipping costs, a minimum price for the product, a minimum margin for the product, and an inventory level of the product.

6. The method of claim 5, wherein displaying of the price adjustment is in response to a predefined trigger.

7. The method of claim 6, wherein the predefined trigger is any one of: a predefined time elapsed since the at least one product was initially added to the electronic shopping cart, navigating away from the e-commerce website, and changing a quantity of the at least one product in the electronic shopping cart.

8. The method of claim 1, wherein generating the price adjustment further comprises:
computing an interest score based on the at least one user-activity parameter, wherein the interest score indicates a degree of interest of the user in the at least one product;
computing a product score based on the at least one product related parameter, wherein the product score that a price of the at least one product can be adjusted; and
computing an adjustment value as a function the interest score and the product score, if the interest score and the product score are above a predefined threshold.

9. The method of claim 8, further comprising:
applying the adjustment value on a current price of the at least one product to result in the price adjustment.

10. A non-transitory computer readable medium having stored thereon instructions for causing one or more processing units to execute the method according to claim 1.

11. A system for generation of real-time personalized price adjustment comprising:
a processor; and,
a memory coupled to the processor, the memory containing instructions that, when executed by the processor, configure the system to:
receive by an e-commerce server a message that at least one product is added to an electronic shopping cart of an electronic-commerce website (e-commerce) displayed on a consumer device;
collect by the e-commerce server at least one user-activity parameter related to a user of the consumer device;
collect at least one product-related parameter to the at least one product;
generate in real-time a price adjustment for purchasing the at least one product, wherein the price adjustment is generated based on the at least one user-activity parameter and the at least one product-related parameter; and
display of the price adjustment in the electronic shopping cart in association with the at least product type.

12. The system of claim 11, further comprising:
storing the user-activity parameters in a database.

13. The system of claim 11, wherein the message is received from any one of:
the consumer device, a web source hosting the e-commerce website.

14. The system of claim 11, wherein the at least one user-activity parameter includes at least one of: behavioral information, shopping history information, and demographic information.

15. The system of claim 11, wherein the at least one product-related parameter includes at least one of: a type of product, a product price, shipping costs, a minimum price for the product, a minimum margin for the product, and an inventory level of the product.

16. The system of claim 15, wherein displaying of the price adjustment is in response to a predefined trigger.

17. The system of claim 16, wherein the predefined trigger is any one of: a predefined time elapsed since the at least one product was initially added to the electronic shopping cart, navigating away from the e-commerce website, and changing a quantity of the at least one product in the electronic shopping cart.

18. The system of claim 11, wherein the system is further configured to:
compute an interest score based on the at least one user-activity parameter, wherein the interest score indicates a degree of interest of the user in the at least one product;
compute a product score based on the at least one product related parameter, wherein the product score that a price of the at least one product can be adjusted; and
compute an adjustment value as a function the interest score and the product score, if the interest score and the product score are above a predefined threshold.

19. The system of claim 18, the system is further configured to:
apply the adjustment value on a current price of the at least one product to result in the price adjustment.
